(19) United States
(12) Patent Application Publication
(10) Pub. No.: US 2013/0047094 A1
(43) Pub. Date: Feb. 21, 2013

(54) Method and system for capturing and sharing expert knowledge and individual preferences via interactive rating cards to derive multidimensional social rating system

(71) Applicants: Radoslav P. Kotorov, Somerset, NJ (US); Yoshiko Akai, New York, NY (US)

(72) Inventors: Radoslav P. Kotorov, Somerset, NJ (US); Yoshiko Akai, New York, NY (US)

(21) Appl. No.: 13/567,992

(22) Filed: Aug. 6, 2012

Related U.S. Application Data
(60) Provisional application No. 61/575,036, filed on Aug. 15, 2011.

(51) Int. Cl. G06F 3/01

(52) U.S. Cl. 715/753

(57) ABSTRACT

A method and system for individuals to capture, store, and organize their knowledge and preferences about goods and services in digital sharable interactive rating cards. The method provides means to capture pictures, video, audio, and text into structured digital rating cards via computers, smart phones, and other digital devices. The method further provides means to create and assign multidimensional rating scales for inputting preference ratings. The multidimensional ratings scales support different input methods based on the device and the underlying scales' attributes. The method further provides means to share the rating cards on social media sites, and to capture all social interactions into secondary aggregated ratings that indicate the overall social assessment of the value of the items displayed in individual rating cards. The system also provides means for advertisers and businesses to place contents and rewards the user.

### FIELD OF THE INVENTION

This invention relates to the techniques for creating value scales and for rating items within digital collections, more particularly, in addition to the prior art, it provides the ability to create interactive digital rating cards with a dual-function event-sensitive content container for displaying item images and for applying multidimensional attribute value ratings.

### BACKGROUND OF THE INVENTION

Digital collections are becoming increasingly popular due to the wide adoption of social media, which gives people the ability to share online events, facts, and other types of personal and public content. Mobile devices, such as smart phones and tablets, further facilitate the proliferation and sharing of user created content in general and of personal collections in particular. People like to take pictures, add comments, and share them with their social friends, who in turn can vote by pressing a “Like” button for example.

The creation and sharing of personal digital collections or catalogues is a relatively new phenomenon within the social media sites and the technology is still in its infancy. The current digital item cards or collection cards are fairly simple, typically displaying an image of an item, description, user comments, some classification, and an option for social voting such as “Like” button, as can be seen on sites like www.pinterest.com. The functional simplicity is dictated by the desire to keep the user interface and interactions simple so that collection cards can be created and reviewed easily on mobile devices using touch and gestures.

But professional collections are means to organize expert knowledge which requires evaluating and rating items of interest, products, and services on multiple attributes. For example, the consumer electronics products are typically rated on price, performance, design, usability, customer support, etc. As more and more experts begin to use social media for maintaining and sharing their knowledge in the form of digital collections, it becomes necessary to expand the capabilities of the current digital collection cards into interactive digital rating cards that provide means for creating and applying multidimensional rating scales to the items of interest. Such multidimensional interactive rating card will allow experts to easily maintain, enhance, and expand their digital collections when they are on the go by using their mobile device. It will also allow experts to collect robust social ratings from other users and to benchmark their own knowledge versus the collective knowledge and social opinions. The robust information will allow advertises and retailers append precisely targeted coupons and discounts to each rating card. The present invention provides the means to fulfill these needs.

### SUMMARY

In accordance with the embodiments described herein, a method and a system is disclosed for the creation and utilization of digital interactive multidimensional rating cards. This summary is not an extensive overview, and it is not intended to identify key/critical elements or delineate the scope thereof Its sole purpose is to present some concepts in a simplified form as a prelude to more detailed description that is presented later.

The method of the invention provides means for individuals to initialize an application template for the creation of individual item-specific rating cards and to add images and other descriptive attributes of the items displayed in the rating cards. The displayed image is overlaid with a transparent or semi-transparent multidimensional value scale for the user to apply multiple attribute ratings by using touch, gestures, or mouse clicks directly over the image area. The ratings can be adjusted or modified at any time using touch, gestures, or mouse clicks. The rating cards are stored on a server and can be shared with friends or the general public via web sites, social media sites and other applications. When the rating cards are shared, other people can provide their own multidimensional ratings. The social ratings are stored separately from the user ratings and can be presented as individual or aggregated ratings. The attribute rating values can be displayed in numeric format, as color coded swatches, or as symbols.

The method and system also provides means to create custom multidimensional rating scales that represent the expert's valuation methodology for different types of collections accurately. The different multidimensional rating scales can be applied to different collections. The method automatically adjusts the configuration of the event-sensitive multi attribute scale that overlays the image display based on the type of scale created by the user in order to simplify the attribute values input. The method provides three types of scales: a binary correlated scale, a binary uncorrelated scale, and a multi-attribute integrated scale. In a binary correlated scale, the attribute rating value pairs High/High and Low/Low are correlated thus allowing the user to assign a combined rating with a single gesture by tapping once within the event-sensitive rectangular area where the item image is displayed. The binary uncorrelated scale can be configured either as a single tap event-sensitive rectangular area analogous to the binary correlated scale or as a split area scale which requires the user to tap and drag or to use two taps in order to assign the ratings for each attribute. In a binary uncorrelated scale, the single tap method requires more thought as the High value for one of the attributes is co-located with the Low value of the other attribute within the event-sensitive rectangular area where the item image is displayed. For the multi-attribute integrated scale, the event-sensitive rectangular area is split into separate rating zones—one for each attribute scale. The method allows the user to page through multiple attribute scales when they all cannot fit within a single rectangular event-sensitive area.

The present invention offers advantages and improvements over prior art because it allows to assign multi-attribute ratings to items within collections easily. Prior systems deploy survey like interfaces where the items are displayed separately from the rating scales and the rating scales are typically implemented as a set of survey questions. Such approaches are not suitable for mobile devices, do not take full advantage of the touch screen technologies, and inhibit the spontaneity associated with social media collective responses, which is precisely why the “Like” button is the dominant method for providing the approval ratings in social media. The present invention offers a compact design that combines the display of an item with the rating method into a single visual component, thus, making it easier to comprehend and interact with the rating card using touch and gestures, especially on mobile devices and on the touch screen computers that are forthcoming to the market.

### BRIEF DESCRIPTION OF THE DRAWINGS

FIG. 1 illustrates a digital interactive rating card with a binary rating scale;

FIG. 2 illustrates a digital interactive rating card with an integrated multidimensional rating scale and a symbolic representation of the rating values;

FIG. 3A illustrates a binary correlated interactive rating scale;

FIG. 3B illustrates a binary uncorrelated interactive rating scale with a single attribute ratings assignment area;

FIG. 4 illustrates a binary uncorrelated interactive rating scale with a split attribute rating assignment area;

FIG. 5 illustrates a multidimensional rating scale with a split attribute rating assignment area.

### DETAILED DESCRIPTION OF THE INVENTION

Various embodiments of the present invention will be described in detail with the reference to the drawings, where like reference numerals represent like parts and assemblies throughout the several views. References to various embodiments do not limit the scope of the invention, which is limited only by the scope of the claims attached hereto. Additionally, any examples set forth in this specification are not intended to be limiting and merely set forth some of the many possible embodiments for the claimed invention. Among other things, the present invention may be embodied as methods or devices. Accordingly, the present invention may take the form of an entirely hardware embodiment, and entirely software embodiment, or an embodiment combining software and hardware aspects. The following detailed description is, therefore, not to be taken in a limiting sense.

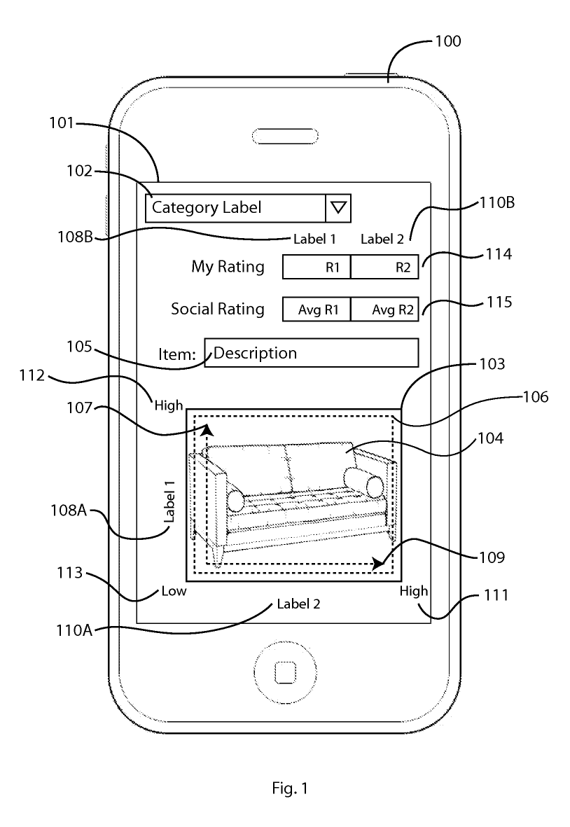

FIG. 1 shows a digital interactive rating card 101 displayed on a mobile device 100. A drop-down component 102 allows users to select a classification category for the rating card 101. The classification categories may or may not be correlated with the application of different multidimensional rating scales. An event-sensitive rectangular container component 103 displays an item image 104 overlaid with a multidimensional rating scale 106 for selecting attribute values by using touch, gestures, mouse click, or other events. The item description 105 illustrates one of many possible user created descriptive attributes. 107 and 109 are the two attribute scales integrated into the multidimensional rating scale 106. 108A is a label for attribute scale 107 that indicates to the user its location within the event-sensitive rectangular container component 103. 112 and 113 show respectively the High and Low points of the scale 107 for users to identify the scale values direction along the event-sensitive rectangular container component 103. 110A is a label for the attribute scale 109 that indicates to the user its location within the event-sensitive rectangular container component 103. 111 and 113 show respectively the High and Low points of the scale 109 for users to identify the scale values direction along the event-sensitive rectangular container component 103. The user rating values component 114 shows the corresponding attribute values for each scale that were selected by using touch, gestures or mouse events on the event-sensitive rectangular container component 103. The rating value R1 represents a selection on scale 107, and the rating value R2 a selection on scale 109. The social ratings values component 115 shows the aggregated attribute values for each scale that were selected by other users when the digital interactive rating card 101 is shared. The average rating value Avg R1 represents the aggregated value for selections made on scale 107, and the average rating value Avg R2 for selections made on scale 109. For those skillful in the art, it is obvious that non-aggregated social ratings can be displayed in a tabular grid, scrollable container, or another component. 108B and 110B are the scale labels for the rating values display components 114 and 115. The 108B and 110B label values are identical to those of labels 108A and 110A.

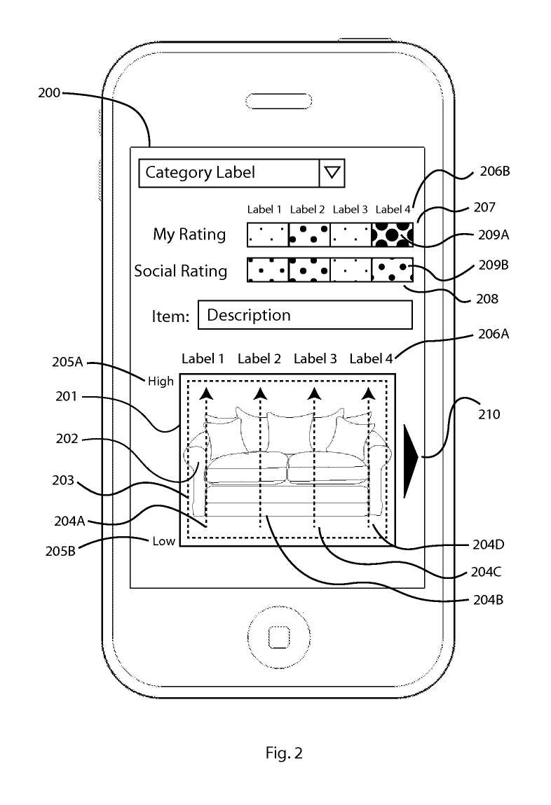

FIG. 2 shows a digital interactive rating card 200 with a multidimensional rating scale 203 and a split attribute rating assignment areas for the individual attribute rating scales 204A, 204B, 204C, and 204D. An event-sensitive rectangular container component 201 displays an item image 202 overlaid with the multidimensional rating scale 203 for selecting multiple attribute values by using touch, gestures, mouse click, or other events. Labels 205A and 205B indicate that the rating values for all scales 204A, 204B, 204C, and 204D increase vertically within the event-sensitive rectangular container component 201. Thus, users' interactions will assign low attribute values when applied at the bottom and high attribute values when applied at the top of the event-sensitive rectangular container component 201. 206A shows the individual labels for each of the individual attribute rating scales 204A, 204B, 204C, and 204D that allow users to identify the slit attribute rating assignment areas within the event-sensitive rectangular container component 201. The user rating values component 207 shows the corresponding attribute values for each of the four scales 204A, 204B, 204C, and 204D that were selected by using touch, gestures or mouse events on the event-sensitive rectangular container component 201. The social ratings values component 208 shows the aggregated attribute values for each of the four scales 204A, 204B, 204C, and 204D that were selected by other users when the digital interactive rating card 200 is shared. 206B shows the individual attribute labels for the rating values display components 207 and 208. 209A and 209B show a symbolic representation of the value ratings using a “dot” symbol. Different “dot” sizes correspond to different value ratings with larger symbols typically representing higher rating values. For those skillful in the art, it will be obvious that many different symbolic and color coded representations are possible to substitute for the numeric representations of the values shown on FIG. 1. 210 is a paging button that allows applying another multidimensional value scale to the event-sensitive rectangular container component 201 when more attribute ratings are required for the precise evaluation of an item. For those skillful in the art, it will be obvious that many paging methods exist to switch rating scales.

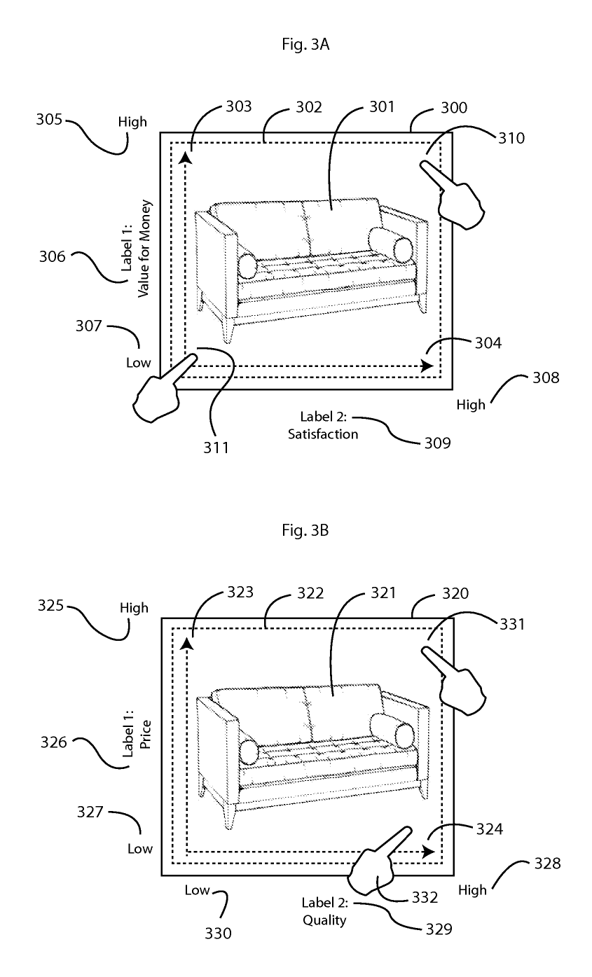

FIG. 3A shows an event-sensitive rectangular container component 300 displaying an item image 301 overlaid with a binary correlated rating scale 302 for selecting attribute values by using a single tap or a single mouse click event. 303 and 304 are the two attribute scales that comprise the binary correlated rating scale 302. 306 and 309 are the labels for the attribute value scales 303 and 304. Labels 305 and 307 indicate the direction in which the ratings increase for the attribute value scale 303. Labels 307 and 309 indicate the direction in which the ratings increase for the attribute value scale 304. In the binary correlated scale 302, a vertical movement along both scales indicates an overall improvement in the value of the item and vise versa. For example, “High” Value-for-Money and “High” Satisfaction (as shown by gesture 310) is better than “Low” Value-for-Money and “Low” Satisfaction (as shown by gesture 311). The binary rating value pairs are correlated because they increase or decrease linearly (in equal proportions) as one moves along the bottom-left/top-right diagonal of the event-sensitive rectangular container component 300. The visual perception of tapping on the item image 301 to assign rating values makes the binary correlated rating scale 302 quite intuitive and easy to use.

FIG. 3B shows an event-sensitive rectangular container component 320 displaying an item image 321 overlaid with a binary uncorrelated rating scale 322 for selecting attribute values by using a single tap or single mouse click event. 323 and 324 are the two attribute scales that comprise the binary uncorrelated rating scale 322. 326 and 329 are the labels for the attribute value scales 323 and 324. Labels 325 and 327 indicate the direction in which the ratings increase for the attribute value scale 323. Labels 328 and 330 indicate the direction in which the ratings increase for the attribute value scale 324. In the binary uncorrelated scale 322, a vertical movement along both scales does not necessarily indicate an overall improvement in the item valuation as it is the case with the binary correlated scale shown on FIG. 3A. For example, “High” Price and “High” Quality (as shown by gesture 331) is not necessarily better than “Low” price and “High” quality (as shown by gesture 332). The binary rating value pairs are uncorrelated because the overall value depends on inverse ratings, e.g. High/Low value pairs. Like the binary correlated scale shown on FIG. 3A, the binary uncorrelated scale 322 makes it possible to assign binary rating values with a single tap or event. The visual perception of tapping on the item image 321 to assign rating values makes the binary uncorrelated rating scale 322 quite intuitive and easy to use.

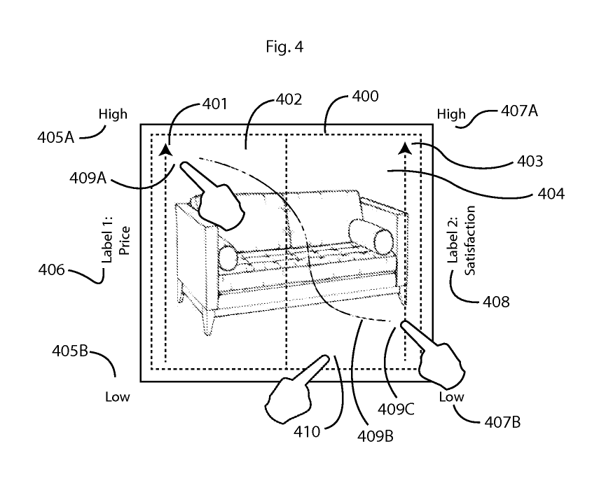

FIG. 4 shows a binary uncorrelated rating scale 400 with two attribute rating assignment areas 402 and 404 for the two attribute value scales 401 and 403. Labels 405A and 405B indicate the direction in which the ratings increase for the attribute value scale 401. Labels 407A and 407B indicate the direction in which the ratings increase for the attribute value scale 403. 406 and 408 are the labels for attribute value scales 401 and 403. Attribute values for each scale can be applied by taping anywhere within the attribute rating assignment areas 402 and 404 as shown in gestures 409A, 409C, and 410. Unlike in FIGS. 3A and 3B where ratings are applied with a single gesture or event, in a binary rating scale 400 with two attribute rating assignment areas 402 and 404, ratings are assigned with a sequence of taps and gestures, such as the sequence 409A (tap), followed by 409B (drag gesture), and 409C (hold gesture). For those skillful in the art, it will be obvious that many different sequences of gestures and mouse events may be conceived for attribute value selections over multiple attribute ratings assignment areas.

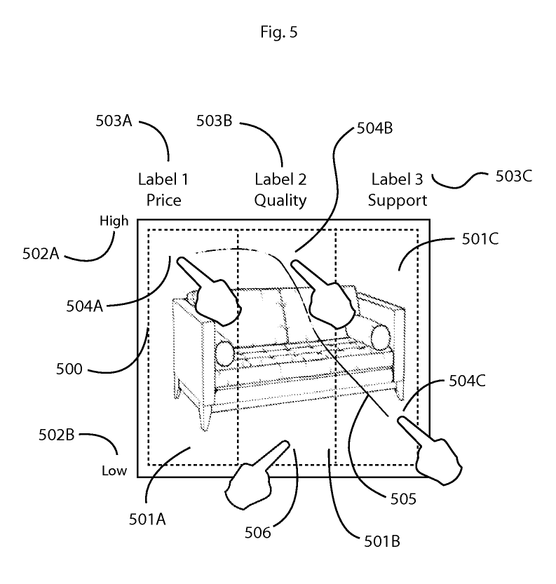

FIG. 5 shows a multidimensional rating scale 500 with three rating assignment areas 501A, 501B, and 501C. Labels 502A and 502B indicate the direction in which the ratings increase for all three rating assignment areas 501A, 501B, and 501C. 503A, 503B, and 503C are the labels for attribute value scales allowing users to identify the relative positioning of each of the three rating assignment areas 501A, 501B, and 501C. 504A, 504B, and 504C shows a sequence of gestures to assign attribute value ratings within each of the three rating assignment areas 501A, 501B, and 501C. The gestures 504A, 504B, and 504C can be individual taps, or tap, drag and hold sequence, or mouse events. Individual attribute values can be modified by tapping once as shown by gesture 506 within the rating assignment areas as shown in area 501B.

What is claimed is:

1) Computer based method for creating multi-attribute rated collection cards by an electronic device user comprising:
Initializing a structured template with user definable attributes;
Inserting a descriptive image;
Overlaying the said descriptive image with an event-sensitive multi-attribute scale;
Selecting multiple rating values by tapping or clicking on the said descriptive image;
Collecting social ratings from other users via the interne;

2) The method of claim 1 further comprising the step of:
Creating and applying different multi-attribute scales.

3) The method of claim 1 further comprising the step of:
Defining algorithmically different value input zones based on attribute rating values correspondence.

4) The method of claim 1, wherein the said event-sensitive multi-attribute scale has variable transparency.

5) The method of claim 1, wherein the event-sensitive multi-attribute scale comprises a binary correlated value selection area for inputs by a single tap, mouse click, or event.

6) The method of claim 1, wherein the event-sensitive multi-attribute scale comprises a binary uncorrelated value selection area for inputs by a single tap, mouse click, or event.

7) The method of claim 1, wherein the event-sensitive multi-attribute scale comprises a multi zone value selection area for inputs using sequential combinations of taps, gestures, mouse clicks, or events.

8) The method of claim 1, wherein the electronic device is a computer, smart phone, or a tablet.

9) Digital interactive rating component comprising:
An image display container;
An event-sensitive input controller overlaying the said image display container;
A multi-attribute scale mapped to the said event-sensitive input controller.

10) The digital interactive rating component of claim 9, wherein the number and types of attributes comprising the said multi-attribute scale are user definable.

11) The digital interactive rating component of claim 9, wherein the attribute value ranges are user definable.

12) The digital interactive rating component of claim 9, wherein attribute labels can be displayed along the said event-sensitive input controller.

13) The digital interactive rating component of claim 9, wherein the transparency of the said event-sensitive input controller and of the said multi-attribute scale can be varied.

14) The digital interactive rating component of claim 9, wherein the said event-sensitive input controller further comprises of:
A single event-sensitive zone for binary value collection.

15) The digital interactive rating component of claim 9, wherein the said event-sensitive input controller further comprises of:
Multiple event-sensitive zones for sequential value collection.

16) Digital multidimensional rating scale comprising:
Multi-attribute rectangular map;
Adjustable attribute value scales mapped to the said multi-attribute rectangular map;
Event-sensitive zones on the said multi-attribute rectangular map corresponding to the said mapped attribute value scales;

17) The digital multidimensional rating scale of claim 16 further comprising:
A single input zone binary correlated rating scale.

18) The digital multidimensional rating scale of claim 16 further comprising:
A single input zone binary uncorrelated rating scale.

19) The digital multidimensional rating scale of claim 16 further comprising:
A split input zone binary uncorrelated rating scale.

20) The digital multidimensional rating scale of claim 16 further comprising:
An n-dimensional split zone rating scale.

21) The digital multidimensional rating scale of claim 16 further comprising of:
Means to superimpose it over digital content.
